(19) United States
(12) Patent Application Publication
(10) Pub. No.: US 2026/0009282 A1
(43) Pub. Date: Jan. 8, 2026

(54) FRAMES FOR A PANEL OF A MOVABLE BARRIER

(71) Applicant: Overhead Door Corporation, Lewisville, TX (US)

(72) Inventors: Bradley J. Lee, Arlington, TX (US); Danny L. Preising, JR., Massillon, OH (US)

(21) Appl. No.: 18/933,841

(22) Filed: Oct. 31, 2024

Related U.S. Application Data
(60) Provisional application No. 63/667,353, filed on Jul. 3, 2024.

(51) Int. Cl. E06B 3/48; E06B 3/58; E06B 3/70

(52) U.S. Cl. CPC E06B 3/485; E06B 3/5892; E06B 2003/7044

(57) ABSTRACT

A movable barrier system having a one-piece frame for a panel of a movable barrier may include a panel comprising an opening. The one-piece frame may be configured to be positioned within the opening in a manner that at least one outer surface of the one-piece frame couples with at least a portion of the panel. An inner surface of the one-piece frame may be substantially opposite the outer surface. A member of the one-piece frame may extend at an angle not more than about 90 degrees relative to the inner surface. A ledge of the one-piece frame may extend from the inner surface. A pane may be configured to move into a frame opening of the one-piece frame in a manner that the pane engages the member to extend substantially parallel to the inner surface until the pane moves adjacent to the ledge.

### PRIORITY

The present application claims priority to and the benefit of the filing date of U.S. Provisional Patent Application 63/667,353, filed Jul. 3, 2024, and titled “ONE-PIECE FRAME FOR A PANEL OF A MOVABLE BARRIER,” incorporated herein in its entirety for all purposes.

### TECHNICAL FIELD

The present disclosure relates generally to frame systems for garage doors, gates, and other moveable barriers, and more particularly to one-piece frame systems, devices, and/or methods for reducing required parts when positioning a pane within a panel in a movable barrier system.

### BACKGROUND

Movable barriers, such as garage doors, often include a windowpane positioned between the front and rear surfaces of the movable barrier. A typical pane can be secured in the barrier using a two-piece frame system formed of a front frame and a back frame, which come together on opposing sides of the pane to secure the pane therebetween. However, a two-piece lite frame system can be time-consuming and difficult to install and expensive to inventory and ship. Additionally, the two frames typically are secured together with a significant number of fasteners (e.g., about 10 fasteners for small frames and more than about 36 for large, elongated frames). For example, fasteners may include self-threading screws inserted from the inside frame clearance holes into the screw posts in the outside frame. Further, the frames are typically also secured to a movable barrier with a significant number of screws (e.g., a typical movable barrier may have about 80 to 144 screws). Thus, the various costs of additional frames, fasteners, and/or screws can be significant. These costs may be further compounded, as the variable size of movable barriers may generally require a number of specialized components for each version. Any reduction in required parts for a frame assembly of a movable barrier (while potentially not changing the outer appearance of the frame) may therefore have numerous benefits such as reduced material and capital cost, reduced labor, reduced required inventory and inspection, reduced tooling costs, reduce manufacturing costs, increased purchasing volumes, and more efficient purchasing strategy. Thus, there remains a need for effective ways for reducing required parts when positioning a pane within a panel in a movable barrier system.

### SUMMARY

Embodiments of the present disclosure include systems, devices, and methods of reducing required parts when positioning a pane within a panel in a movable barrier system.

In some examples, a movable barrier system includes a panel including a panel opening. The movable barrier system may further include a one-piece frame configured to be positioned within the panel opening in a manner that an outer surface of the one-piece frame couples with at least a portion of the panel. The one-piece frame defining a frame opening may further include an inner surface substantially opposite the outer surface. The one-piece frame may further include a member extending at an angle not more than about 90 degrees relative to the inner surface. The one-piece frame may further include a ledge extending from the inner surface. The movable barrier system may further include a pane configured to move into the frame opening in a manner that the pane engages the member and elastically deflects the member until the pane moves past the member.

In some examples, a movable barrier system having a one-piece frame for a panel of a movable barrier may further include a panel including an opening. The movable barrier system may further include a one-piece frame being configured to be positioned within the opening in a manner that at least one outer surface of the one-piece frame couples with at least a portion of the panel. The one-piece frame may further include a flange extending at an angle not more than about 90 degrees relative to the outer surface of the one-piece frame in a manner that when the one-piece frame is positioned within the opening, the flange may engage a portion of the panel bending inwardly until the flange reaches an end of the opening. The one-piece frame may further include an outer ledge extending from the outer surface and configured to couple with the panel when the flange reaches an end of the opening.

In some examples, a movable barrier system may include a panel including a panel opening. The movable barrier system may further include a one-piece frame configured to be positioned within the panel opening in a manner that an outer surface of the one-piece frame couples with at least a portion of the panel. The one-piece frame defining a frame opening may further include an inner surface substantially opposite the outer surface. The one-piece frame may further include a member extending at an angle not more than about 90 degrees relative to the inner surface. The one-piece frame may further include a ledge extending from the inner surface. The one-piece frame may further include a flange extending at an angle not more than about 90 degrees relative to the outer surface of the one-piece frame in a manner that when the one-piece frame is positioned within the opening, the flange may engage a portion of the panel bending inwardly until the flange reaches an end of the opening. The one-piece frame may further include an outer ledge extending from the outer surface and configured to couple with the panel when the flange reaches an end of the opening. The movable barrier system may further include a pane configured to move into the frame opening in a manner that the pane engages the member and elastically deflects the member until the pane moves past the member.

In some examples, a movable barrier system having a one-piece frame for a panel of a movable barrier may further include a panel including an opening. The movable barrier system may further include a one-piece frame being configured to be positioned within the opening in a manner that an outer surface of the one-piece frame couples with at least a portion of the panel. The one-piece frame may further include an inner surface substantially opposite the outer surface. The one-piece frame may further include a member extending at an angle not more than 90 degrees relative to the inner surface. The one-piece frame may further include a second member extending at a second angle not more than 90 degrees relative to the inner surface. The one-piece frame may further include a ledge extending from the inner surface. The movable barrier system may further include a pane configured to move into a frame opening of the one-piece frame in a manner that the pane engages the member to extend substantially parallel to the inner surface until the pane moves adjacent to the ledge. The movable barrier system may further include a second pane configured to move into the frame opening of the one-piece frame in a manner that the second pane engages the second member to extend substantially parallel to the inner surface until the second pane moves adjacent to the pane.

In some examples, a frame for placement in a panel opening of a panel of a movable barrier system and defining a frame opening for a pane may include a leading side comprising a flexible flange formed thereon, the flange being configured to flex into a first position while the leading side is introduced into the panel, the flexible flange also being configured to displace to a second position abutting against a first side of the panel adjacent the panel opening. The frame may further include a trailing side comprising a ledge, the ledge being arranged to abut against a second side of the panel opposite the first side of the panel, the ledge being configured to prevent the frame from passing through the panel opening. The frame may further include a member extending inwardly into the frame opening at an oblique angle, the member being configured to flex into a first position while the pane is introduced into the frame, the member also being configured to displace to a second position abutting against a trailing side of the pane in a manner securing the pane in the frame.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 is a perspective view of an example movable barrier system, according to some aspects of the present disclosure.

FIG. 2 is an exploded perspective view of an example frame assembly and panel, according to some aspects of the present disclosure.

FIG. 3 is a side perspective view of an example one-piece frame, according to some aspects of the present disclosure.

FIG. 4 is an exploded perspective view of an example frame assembly, according to some aspects of the present disclosure.

FIG. 5 illustrates an example method of reducing required parts when positioning a pane within a panel in a movable barrier system, according to some aspects of the present disclosure.

FIG. 6A is a front view of an example frame assembly and panel, according to some aspects of the present disclosure.

FIG. 6B is a cross-section view of the example frame assembly and panel in FIG. 6A, according to some aspects of the present disclosure.

FIG. 6C is a cross-section view of the example frame assembly and panel in FIG. 6A, according to some aspects of the present disclosure.

FIG. 6D is a detail view of Detail View Area 6D in the cross-section view of the frame assembly and panel in FIG. 6B, according to some aspects of the present disclosure.

FIG. 7 is another example of a detail view of Detail View Area 6D in the cross-section view of the example frame assembly and panel in FIG. 6B, according to some aspects of the present disclosure.

FIG. 8 is another example of a detail view of Detail View Area 6D in the cross-section view of the example frame assembly and panel in FIG. 6B, according to some aspects of the present disclosure.

FIG. 9 is another example of a detail view of Detail View Area 6D in the cross-section view of the example frame assembly and panel in FIG. 6B if Detail View Area 6D were positioned at the other end of the frame assembly 195 in FIG. 6B, according to some aspects of the present disclosure.

FIG. 10 is another example of a detail view of Detail View Area 6D in the cross-section view of the example frame assembly and panel in FIG. 6B, according to some aspects of the present disclosure.

FIG. 11 is another example of a detail view of Detail View Area 6D in the cross-section view of the example frame assembly and panel in FIG. 6B if Detail View Area 6D were positioned at the other end of the frame assembly 195 in FIG. 6B, according to some aspects of the present disclosure.

FIG. 12A is an exploded perspective view of an example frame assembly and panel, according to some aspects of the present disclosure.

FIG. 12B is a perspective view Sides A and D of an example frame assembly as Sides A and D are labeled in FIG. 12A, according to some aspects of the present disclosure.

FIG. 12C is a perspective view Sides B and C of an example frame assembly as Sides B and C are labeled in FIG. 12A, according to some aspects of the present disclosure.

FIG. 13 is an exploded perspective view of an example frame assembly and panel, according to some aspects of the present disclosure.

FIG. 14 is a perspective cross-section view of an example frame assembly and panel, according to some aspects of the present disclosure.

FIG. 15 is a side cross-section view of an example frame assembly and panel, according to some aspects of the present disclosure.

FIG. 16 is a side cross-section view of an example frame assembly and panel, according to some aspects of the present disclosure.

FIG. 17 is a side cross-section view of an example frame assembly and panel, according to some aspects of the present disclosure.

FIG. 18 is a side cross-section view of an example frame assembly and panel, according to some aspects of the present disclosure.

FIG. 19 is a side cross-section view of an example frame assembly and panel, according to some aspects of the present disclosure.

FIG. 20 is an exploded perspective view of an example frame assembly and panel, according to some aspects of the present disclosure.

FIG. 21 is a side cross-section view of an example frame assembly and panel, according to some aspects of the present disclosure.

FIG. 22 is a cross-sectional perspective view of an example frame, according to some aspects of the present disclosure.

FIG. 23 is a cross-sectional perspective view of an example frame assembly, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Disclosed herein are one-piece frame systems, methods, and devices for reducing required parts when positioning a pane within a panel in a movable barrier system by securing the pane with one or members and by securing the one-piece frame with one or more flanges. Thus, the present disclosure allows for the securing of a pane within a section panel of a movable barrier with a one-piece frame, thereby effectively reducing the total parts required for a frame assembly.

The one-piece frames discussed further herein may receive and quickly secure in place panes of varying thickness and may quickly be inserted and secured into a section panel of a movable barrier without requiring fasteners. In some implementations, a one-piece frame may include one or more members extending into a frame opening of the one-piece frame. A pane may be moved into the frame opening such that the pane may engage the one or members causing the one or more members to bend away from the pane. As the pane moves adjacent to a ledge, the pane may pass the one or more members allowing the one or more members to snap back into substantially their original position and secure the pane in place.

In some implementations, a one-piece frame may further include one or more flanges extending at an angle relative to an outer surface. The one-piece frame may be moved into an opening of a section panel such that the one or more flanges may engage with the section panel and bend towards the one-piece frame. As an outer ledge of the one-piece frame moves adjacent to the section panel, the one or more flanges may reach an end of the opening and snap back into substantially their original position and secure the one-piece frame in place. In some implementations, the one-piece frame may couple with a decorative trim which may be positioned between one or more flanges of the one-piece frame and the inwardly-facing side of the section panel.

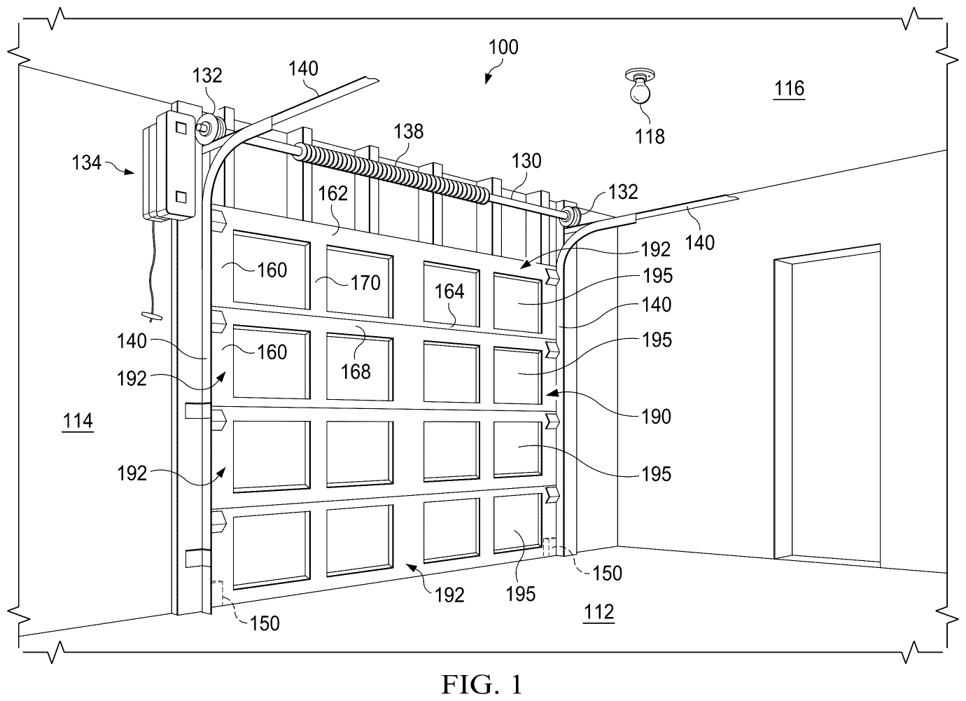

FIG. 1 is a perspective view of an example movable barrier system 100, according to some aspects of the present disclosure. FIG. 1 illustrates a movable barrier 190 and a barrier operator 134. In this example, the movable barrier 190 may be an upward acting garage door. In some examples, the movable barrier 190 may be a sectional-type garage door. The movable barrier 190 may include various panels such as opaque, transparent, and/or semi-transparent panels.

In some implementations, the movable barrier system 100 described herein may be referred to as a barrier system, a door system, a garage door system, a gate system, or any other similar term. In some implementations, the movable barrier 190 may be referred to as a barrier, a door, a garage door, a sectional garage door, an upward acting garage door, a gate, a movable gate, a sliding gate, or any other similar term. In some implementations, the barrier operator 134 may alternatively be referred to as an operator, a door operator, a garage door operator, a gate operator, an opener, a door opener, a garage door opener, a gate opener, a control system, or any other similar term.

FIG. 1 shows that the movable barrier 190 provides access to a space or a room having a floor 112. The movable barrier 190 may provide selective access to the space. In the closed position shown in FIG. 1, the movable barrier 190 may be positioned within an opening of a wall, such as wall 114. The barrier operator 134 may be any suitable type of barrier operator. For example, in some implementations, the barrier operator 134 may be a jackshaft operator. In other implementations, the barrier operator 134 may be a trolley operator, a direct drive wall or ceiling mounted operator, a belt driven operator, a chain driven operator, a screw drive operator, and/or any other type of barrier operator. The barrier operator 134 may include any suitable components. As shown in FIG. 1, the barrier operator 134 may be disposed adjacent to the movable barrier 190. For example, in the implementation shown, the barrier operator 134 may be positioned on the wall 114. However, the barrier operator 134 may be positioned at any other location within the room shown in FIG. 1. For example, the barrier operator 134 may be affixed to the ceiling 116. In some implementations, the barrier operator 134 may be positioned on a different wall of the room or on the floor 112 of the room. In some implementations, particularly in an implementation in which the barrier operator 134 is affixed or otherwise positioned on the ceiling 116 of the room, the light fixture 118 shown may be attached to, or a part of, the barrier operator 134.

Any suitable structures or components may be implemented to facilitate movement of the movable barrier 190 between a closed position and an open position. In the example shown in FIG. 1, the movable barrier 190 may be moved along one or more tracks 140.

FIG. 1 illustrates the movable barrier 190 as an upward acting sectional door being movable between open and closed positions along the tracks 140. Tracks 140 may be affixed to either side of the opening of the movable barrier 190. In some implementations, the tracks 140 may be affixed to the wall 114 shown in FIG. 1 and/or the ceiling 116. In some implementations, the movable barrier 190 may include one or more rolling or sliding components on either side sized and shaped to fit within and move in a longitudinal direction along the tracks 140. The rolling or sliding components may be affixed to brackets positioned on either side of the movable barrier 190.

Components of the movable barrier system 100 shown in FIG. 1 may include any other suitable components. For example, the movable barrier system 100 may include rollers positioned on the movable barrier 190 or the tracks 140. The movable barrier system 100 may include additional sensors, such as safety sensors able to detect the presence or motion of an object or person and/or seals positioned along any portion of the movable barrier 190 or the corresponding opening, rails, cables, and/or tube shafts. The system may include extension springs to further reduce necessary rotational force of a motor, a motor rail, belts, motor head, motor arms, lift handles for manual operation, emergency release ropes, and/or any other suitable components.

In some implementations, the movable barrier system 100 may additionally include cable drum assemblies 132, a torsion tube 130, and a torsion spring assembly 138. The movable barrier system 100 may additionally include a cable (not shown) attached to the cable drum assemblies 132 and connectors 150 which form a part of the movable barrier 190. In some implementations, the barrier operator 134 may include a motor or similar component which may automatically open and/or close the movable barrier 190 by rotating the torsion tube 130 in a first direction and/or in a second direction. It should be understood that as used herein, the term torsion tube 130 includes hollow tubes as well as solid shafts and bars.

In some implementations, the movable barrier 190 may include one or more sections 192. In the example shown in FIG. 1, the movable barrier 190 may include one or more sections 192 including at least some or all of frame assemblies 195, stiles 160, upper rails 162, 168, and/or lower rails 164. It should be understood that the sections 192 may be referred to by other terms such as section panel, panel, frame, section pan, pan, and/or any other suitable term. In the example shown in FIG. 1, a section 192 may include an upper rail 162 and a lower rail 164. In some implementations, the rail 164 may couple with and/or be hingedly connected to the rail 168. In some implementations, the rail 162 may be referred to as a first rail. In some implementations, the rail 164 may be referred to as a second rail.

In some implementations, a section panel 192 may include a first rail 162, and a second rail 164, a first stile 160, and a second stile 170. Stiles 160, 170 may couple with the first rail 162 and the second rail 164. In some implementations, lengthwise axes of stiles 160, 170 may be wholly or substantially perpendicular to a lengthwise axis of the first rail 162 and/or a lengthwise axis of the second rail 164. In some implementations, a lengthwise axis of the first rail 162 may be wholly or substantially parallel to a lengthwise axis of the second rail 164. In some implementations, the second rail 164 may be coupled to a third rail 168 of a second panel 192. The second rail 164 may be coupled to the third rail 168 by any mechanism, such as a hinge. In some implementations, the second rail 164 may be coupled to the third rail 168 by a geared hinge, but it should be understood that the second rail 164 and the third rail 168 could be coupled by any type of hinge, such as a barrel hinge, butt hinge, spring-loaded hinge, concealed hinge, overlay hinge, strap hinge, ball-bearing hinge, offset hinge, scissor hinge, continuous hinge, and/or double-action spring hinge.

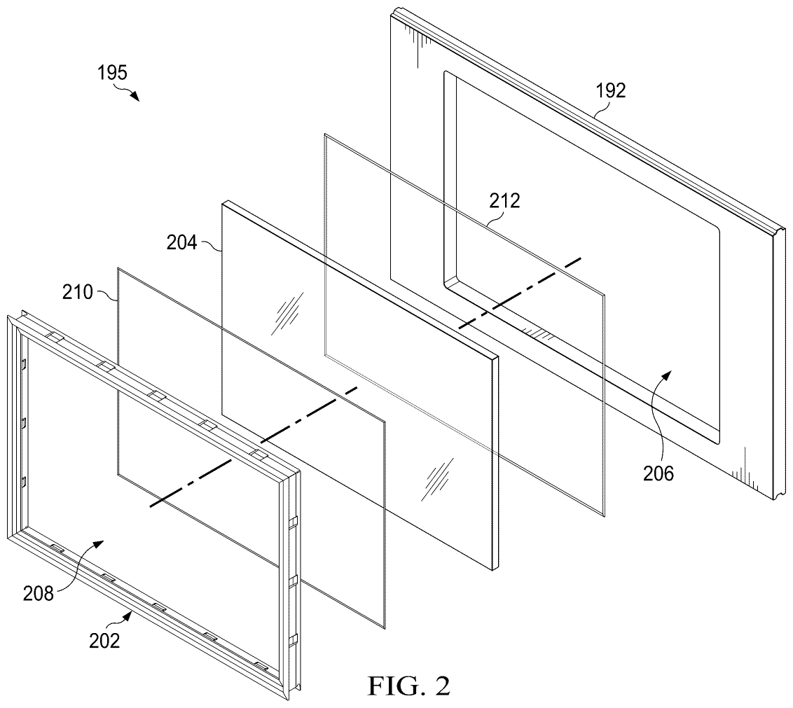

FIG. 2 is an exploded perspective view of an example frame assembly 195 and panel 192, according to some aspects of the present disclosure. Implementations of a frame assembly 195 are shown in FIG. 2 as exploded to more clearly show elements of the frame assembly 195 and show how elements of the frame assembly 195 may couple together.

The frame assembly 195 may further include a one-piece frame 202 and a pane 204. As shown in the example of FIG. 2, the one-piece frame 202 may be positioned at least partially within the panel opening 206 of the movable barrier 190. The one-piece frame 202 may be made of any material such as vinyl, polyvinyl chloride (PVC), acrylonitrile styrene acrylate (ASA), plastic, sheet metal, steel, iron, metal, alloy, ceramic, wood, any material resistant to deflection, and/or any other type of suitable material. In some implementations, the one-piece frame 202 may be created using injection molding. As further shown in the example of FIG. 2, the pane 204 may be positioned at least partially within the frame opening 208 of the one-piece frame 202. The pane 204 and any other panes discussed herein may be made of any material such as materials that are clear, transparent with special coatings, translucent, semi-translucent, and/or opaque and such as glass, plastic, plexiglass, acrylic, polycarbonate, and/or any other type of suitable material. It should be understood that depending on the implementation, the pane 204 and any other panes discussed herein may be referred to by any suitable term such as a lite, window, window pane, glazed window, glazing panel, glazed panel, translucent panel, clear panel, glass, glass pane, and/or any other suitable term. It should also be understood that depending on the implementation, the pane 204 and any other panes discussed herein may have any thickness such as about 5/32 inches, about ⅛ inches, about ¼ inches, about ½ inches, about 5/32 to ½ inches, and/or any other suitable thickness, including thicknesses larger or smaller than the examples provided. It should also be understood that depending on the implementation, the pane 204 and any other panes discussed herein may have any length and may have any width. For example, in some implementations, the pane 204 and any other panes discussed herein may have a length and/or width within a range of about 5 inches to 15 feet, though larger and smaller widths and lengths are contemplated. In some examples the width is about 21 inches wide by 15 inches tall, and/or about 15 to 25 inches wide by 10 to 20 inches tall. In some examples the width is about 40 inches wide by 15 inches tall, and/or about 35 to 45 inches wide by 10 to 20 inches tall.

In some implementations, the frame assembly 195 may further include sealant bead 210 and second sealant bead 212. The sealant bead 210 may be positioned between the one-piece frame 202 and the pane 204. The second sealant bead 212 may be positioned between the pane 204 (and/or the one-piece frame 202) and the panel 192.

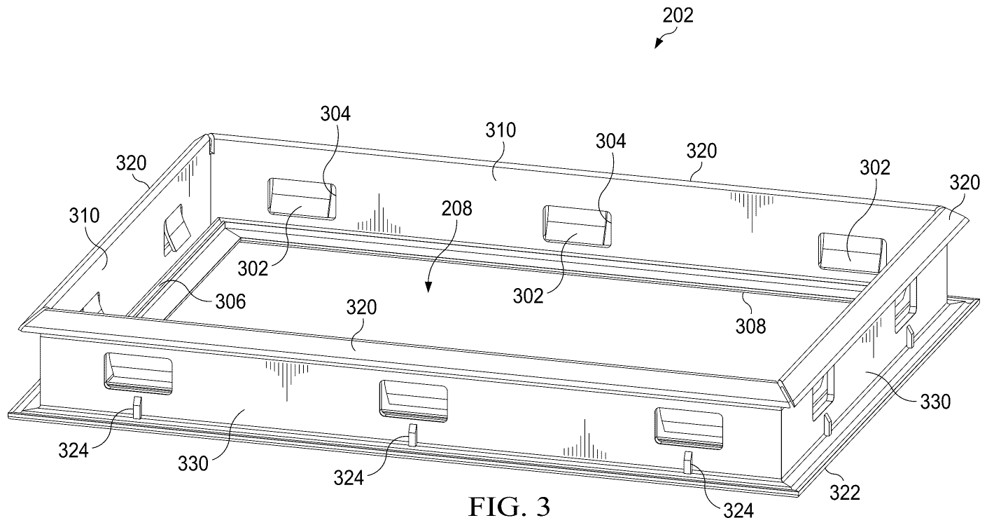

FIG. 3 is a side perspective view of an example one-piece frame 202, according to some aspects of the present disclosure. The one-piece frame 202 may further include at least some or all of one or more members 302, one or more holes 304, a trough 306, a ledge 308, one or more inner surfaces 310, one or more flanges 320, an outer ledge 322, one or more spacers 324, one or more outer surfaces 330.

The one or more members 302, which may also be referred to as locks, snap-locks, hooks, clips, or one-way locks, may extend from and/or be positioned on the one or more inner surfaces 310 and/or a side of a corresponding hole 304 of the one-piece frame 202. The one or more members 302 may extend from the inner surfaces 310 at an angle relative to the surface of the inner surfaces 310. In some implementations, the angle of extension of the member 302 may be between 0 degrees and 90 degrees. The one or more members 302 may be made of the same or different material as the one-piece frame 202. For example, in some implementations, such as the example shown, the one or more members 302 may be part of the original one-piece frame 202 and may be cutout to plastically deform to a position extending inwardly or outwardly from the edge of the frame 202, such as at the angle of extension shown. In some examples, instead of being of the same frame material, the members 302 may be made of a more flexible and/or more durable material than the rest of the one-piece frame 202. The one or more members 302 may be configured to flex in response to the insertion of a pane 204 into the frame opening 208 of the one-piece frame 202. In some implementations, the insertion of a pane 204 into the frame opening 208 of the one-piece frame 202 may cause the one or more members 302 to flex into the one or more holes 304 such that a surface plane of the one or more members 302 is substantially or fully parallel to the corresponding inner surface 310 and/or the corresponding outer surface 330. Thus, when the one or more members 302 bend, the pane 204 may slide substantially or fully unobstructedly into the frame opening 208 of the one-piece frame 202. After the pane 204 moves into position within the frame opening 208 of the one-piece frame 202 and couples with the trough 306 and/or the ledge 308, the one or more members 302 may no longer be pressed in by the pane 204 and may elastically return partially or fully to their original position, sometimes snapping into position behind the pane 204, thereby preventing removal of the pane 204 from the frame 202. In some implementations, the extension length of the one or more members 302 may be adjusted such that when the pane 204 moves into position within the frame opening 208 of the one-piece frame 202 and couples with the trough 306 and/or the ledge 308, an end surface of the one or more members 302 may couple with a surface of the pane 204 to hold the pane 204 in position.

In some implementations, one or more holes 304 may be positioned adjacent to the one or more members 302 such that the one or more holes 304 may be sized and shaped similarly to the one or more members 302. In some implementations, the size of the one or more holes 304 may include sufficient clearance to prevent the one or more members 302 from clipping or scraping the side on the one or more holes 304. In some implementations, any or some corners of the one or more members 302 and/or the one or more holes 304 may include a fillet or chamfer.

The inner surfaces 310 may extend along at least a portion of the frame opening 208. Two inner surfaces 310 may extend along the length of the one-piece frame 202 and two inner surfaces 310 may extend along the width of the one-piece frame 202. The one or more holes 304 may extend into the inner surfaces 310.

The outer surfaces 330 may be positioned substantially opposite to the corresponding inner surfaces 310. The one or more holes 304 may extend into the inner surfaces 310 and through the outer surfaces 330.

In some implementations, a trough 306 may extend from the inner surfaces 310. The trough 306 may include a recess having an opening plane substantially perpendicular to the inner surfaces 310. In the example shown in FIG. 3, the recess has a curved semi-circular cross-section; however, it should be understood that the recess may have a cross-section of any size and/or shape such as rectangular, square, triangular, semi-elliptical, and/or a complex contour. In some implementations, the recess of the trough 306 may be sized and shaped to receive a sealant bead 210 which may adhere the pane 204 to the one-piece frame 202. In some implementations, the outer ledge 322 may include a second trough in which the second sealant bead 212 may be positioned.

In some implementations, the sealant bead 210 and/or the second sealant bead 212 may be co-molded into the one-piece frame 202. The sealant bead 210 and/or the second sealant bead 212 may be made of any material such as adhesive, glue, foam, plastic, and/or any other type of material capable of creating a seal. In some implementations, the sealant bead 210 and/or the second sealant bead 212 may be configured to create a seal against external conditions such as sound, water, air, temperature, and/or any other type of external condition. In some implementations, tiny flaps and/or a flap seal may be positioned on the trough 306, the ledge 308, and/or the outer ledge 322 to seal the panel opening 206 and/or the frame opening 208 with the pane 204 and/or the panel 192 and may be configured to create a seal against external conditions such as sound, water, air, temperature, and/or any other type of external condition.

The ledge 308 may extend from one end of the inner surfaces 310. In some implementations, the ledge 308 may extend from an end of the inner surfaces 310 near the outside facing portion of the one-piece frame 202. In some implementations, the ledge 308 may be substantially or fully adjacent to the trough 306. The ledge 308 may couple with the pane 204 when the pane 204 is positioned within the frame opening 208. In some implementations, the ledge 308 may have a thickness such that the pane 204 may be positioned fully and/or partially within the frame opening 208. In some implementations, the ledge 308 may extend a distance from the inner surfaces 310 such that the pane 204 may not be removed from the frame opening 208 in at least one direction. The ledge 308 may have sufficient structural strength to prevent the ledge 308 from breaking and allowing the pane 204 to fall out of the one-piece frame 202.

The one or more flanges 320 may extend from the outer surfaces 330 and/or a side of the one-piece frame 202 between the inner surfaces 310 and the outer surfaces 330. The one or more flanges 320 may extend relative to the outer surfaces 330 at an angle relative to a surface of the outer surfaces 330. In some implementations, the angle of extension of the flange 320 may be between 0 degrees and 90 degrees. The one or more flanges 320 may be made of the same or different material as the one-piece frame 202. For example, in some implementations, the one or more flanges 320 may be made of a more flexible and/or more durable material than the rest of the one-piece frame 202.

The one or more flanges 320 may be configured to flex or bend when the frame 202 is inserted into the panel opening 206 of the section panel 192. In some implementations, the insertion of the one-piece frame 202 into the panel opening 206 of the section panel 192 may cause the one or more flanges 320 to bend inwardly towards the outer surfaces 330 such that a surface plane of the one or more flanges 320 is substantially or fully parallel to the corresponding outer surface 330 and/or the corresponding inner surface 310. Thus, when the one or more flanges 320 bend, the one-piece frame 202 may slide partially or fully unobstructedly into the panel opening 206 of the section panel 192.

After the one-piece frame 202 moves into position within the panel opening 206 of the section panel 192 and the outer ledge 322 couples with a surface of the section panel 192, the flanges 320 may no longer be pressed in by the sides of the panel opening 206 and may return at least partially back to their original position. That is, they may snap back into place, preventing the frame 202 from being removed from the panel opening 206 in the panel 192. Thus, the flanges 320 serve to secure or lock the frame 202 into the panel opening 206. In some implementations, full clearance of the flange 320 past the panel 192 is not necessary before the flange 320 is positioned to secure the panel 192 in place. For example, the installer may use a tool to pull the flange 320 the rest of the way through so it is entirely through the panel opening 206 so that the flange 320 aligns with the corresponding surface of the panel 192, thereby securing the frame 202 in place, and preventing its removal from the panel 192. In some implementations, the extension length of the one or more flanges 320 may be adjusted such that when the one-piece frame 202 moves into position within the panel opening 206, an end surface of the one or more flanges 320 may couple with a surface of the section panel 192 to hold the one-piece frame 202 in position. In some implementations, an end surface of the one or more flanges 320 may couple with an outside surface of the section panel 192 to hold the one-piece frame 202 in position. In some implementations, the one or more flanges 320 may need to be spooned out of the panel opening 206 (similar to spooning a car tire bead on a rim).

The outer ledge 322 may extend from one end of the outer surfaces 330. In some implementations, the outer ledge 322 may include some or all of one or more recesses, one or more slanted portions, and/or one or more curved portions. In some implementations, the outer ledge 322 may couple with a surface of the section panel 192 when the one-piece frame 202 is positioned within the panel opening 206. In some implementations, the outer ledge 322 may have a thickness such that the one-piece frame 202 may be positioned fully and/or partially within the panel opening 206. In some implementations, the outer ledge 322 may extend a distance from the outer surface 330 such that the one-piece frame 202 may not be removed from the panel opening 206 in at least one direction. The outer ledge 322 may have sufficient structural strength to prevent the outer ledge 322 from breaking and allowing the one-piece frame 202 to fall out of the movable barrier 190.

In some implementations, the one or more spacers 324 may extend from the outer surfaces 330. In some implementations, the one or more spacers 324 may be positioned substantially adjacent to the outer ledge 322. In some implementations, the one or more spacers 324 may be positioned below the one or more holes 304. In some implementations, the spacers 324 may position and/or centralize the one-piece frame 202 inside the panel opening 206. The one or more spacers 324 may be configured to structurally support the outer surfaces 330 and/or the one-piece frame 202.

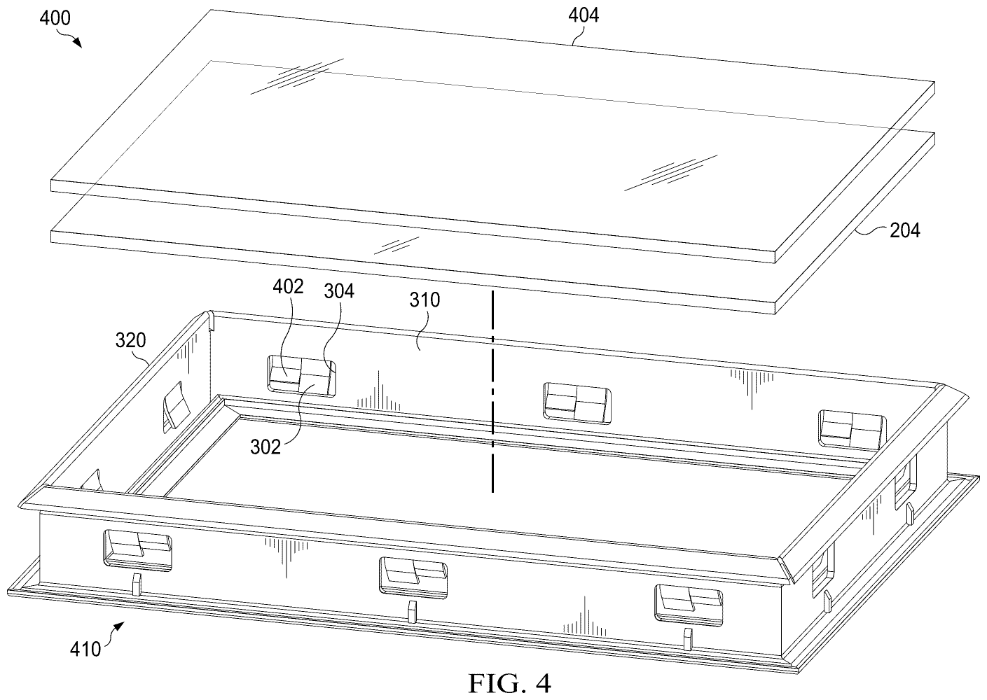

FIG. 4 is an exploded perspective view of an example frame assembly 400, according to some aspects of the present disclosure. In some implementations, the frame assembly 400 may be interchangeable with the frame assembly 195 and may include at least some or all of a one-piece frame 410 and any number of panes, such as a pane 204 and a pane 404. In some implementations, in addition to the one or more members 302, a one-piece frame 410 may further include one or more second members 402. The one or more second members 402 may be provided in the one-piece frame 410 to allow for the installation of a second pane 404 in the frame opening 208. The one or more second members 402 may extend from and/or be positioned on the one or more inner surfaces 310 and/or a side of a corresponding hole 304 of the one-piece frame 410. The one or more second members 402 may extend from the inner surfaces 310 at a second angle relative to the surface of the inner surfaces 310. In some implementations, the angle of extension of the second members 402 may be between 0 degrees and 90 degrees. The one or more second members 402 may be made of the same or different material as the one-piece frame 410. For example, in some implementations, the one or more second members 402 may be made of a more flexible and/or more durable material than the rest of the one-piece frame 410. The one or more second members 402 may be configured to bend in response to the insertion of a second pane 404 into the frame opening 208 of the one-piece frame 410. In some implementations, the insertion of a second pane 404 into the frame opening 208 of the one-piece frame 410 may cause the one or more second members 402 to bend into the one or more holes 304 such that a surface plane of the one or more second members 402 is substantially or fully parallel to the corresponding inner surface 310 and/or the corresponding outer surface 330. Thus, when the one or more second members 402 bend, the second pane 404 may slide partially or fully unobstructedly into the frame opening 208 of the one-piece frame 410. After the second pane 404 moves into position within the frame opening 208 of the one-piece frame 410 and couples with the pane 204, the one or more second members 402 may no longer be pressed in by the second pane 404 and may return at least substantially back to their original position, sometimes snapping the second pane 404 in place. In some implementations, the extension length of the one or more second members 402 may be adjusted such that when the second pane 404 moves into position within the frame opening 208 of the one-piece frame 410 and couples with the pane 204, an end surface of the one or more second members 402 may couple with a surface of the second pane 404 to hold the second pane 404 in position. Thus, the extension length of the one or more second members 402 may be shorter than the extension length of the one or more members 302. For example, the one or more members 302 may each have an extension length of about ⅞ inches while the one or more second members 402 may have an extension length of about ½ inches, though these are merely examples. In some implementations, the width of the one or more members 302 may be decreased to allow for space for the width of the one or more second members 402. In implementations associated with one or more second members 402, the pane 204 may engage the one or more second members 402 when moving into the frame opening 208; however, in some implementations, an end of the one or more second members 402 may not make contact with a surface of the pane 204 when the pane 204 is in position. It should also be understood that depending on the implementation, the one-piece frame 410 may have any number of members having any extension length such that the one-piece frame 410 may hold any number of panes. In some implementations, as the number of members corresponding to a hole 304 increases, the individual widths of the members may decrease to accommodate for the increase in members.

In some implementations, a fixture or device may be provided to press multiple panes, such as panes 204 and second pane 404, into the one-piece frame 202 at the same time to avoid damaging the panes or the one-piece frame 202. This fixture or device may couple the panes together and gradually insert the panes into the frame opening 208.

In some examples, the members are disposed to each secure a pane 204 of a different thickness. For example, a first member is sized to secure a pane 204 having a 0.5 inch thickness and an adjacent second member is sized to secure a pane 204 having a 0.75 inch thickness. The pane 204 may have any number of members to accommodate the different sized panes. In some examples, the pane 204 may have 3 or 4 or 5 different members each arranged and configured to accommodate a pane 204 of a different thickness.

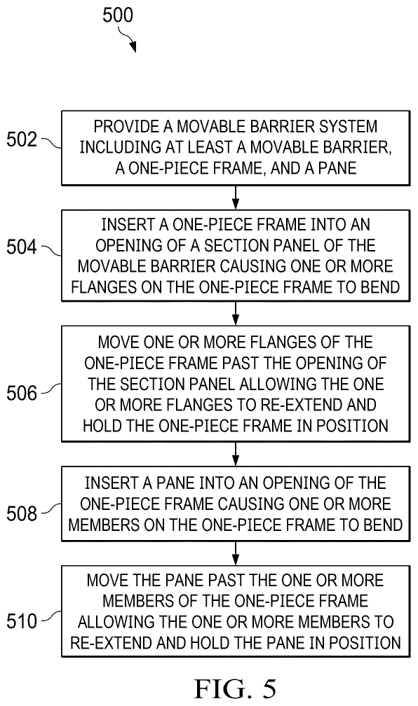

FIG. 5 illustrates an example method 500 of reducing required parts when positioning a pane 204 within a panel 192 in a movable barrier system 100, according to some aspects of the present disclosure. At process 502, a movable barrier system 100 may be provided including at least some or all of a movable barrier 190, a one-piece frame 202, and a pane 204.

At optional process 504, the one-piece frame 202 may be inserted into the panel opening 206 of the section panel 192 of the movable barrier 190 causing one or more flanges 320 on the one-piece frame 202 to bend.

At optional process 506, as the frame 202 is further advanced into the panel opening 206 in the panel 192, the one or more flanges 320 may move past the panel opening 206 of the section panel 192 allowing the one or more flanges 320 to re-extend or snap into place on the opposite side of the panel 192 and prevent the one-piece frame 202 being removed back out from the panel opening 206. Thus, the frame 202 may be held in position.

At optional process 508, the pane 204 may be inserted into the frame opening 208 of the one-piece frame 202 causing one or more members 302 on the one-piece frame 202 to elastically flex or bend. In some implementations, processes 508 and 510 may occur before process 504.

At optional process 510, as the pane 204 moves past the one or more members 302 of the one-piece frame 202, the one or more members 302 elastically deflects or snaps into position behind the pane 204 to hold the pane 204 in position.

It should be appreciated that any of the processes of method 500 may be completed in any order. It should also be appreciated that some or all optional steps may be completed depending on the implementation. The order of the steps in method 500 may be changed indiscriminately as the one-piece frame 202 is inserted into the section panel 192 of a movable barrier 190 and/or the pane 204 is inserted into the one-piece frame 202.

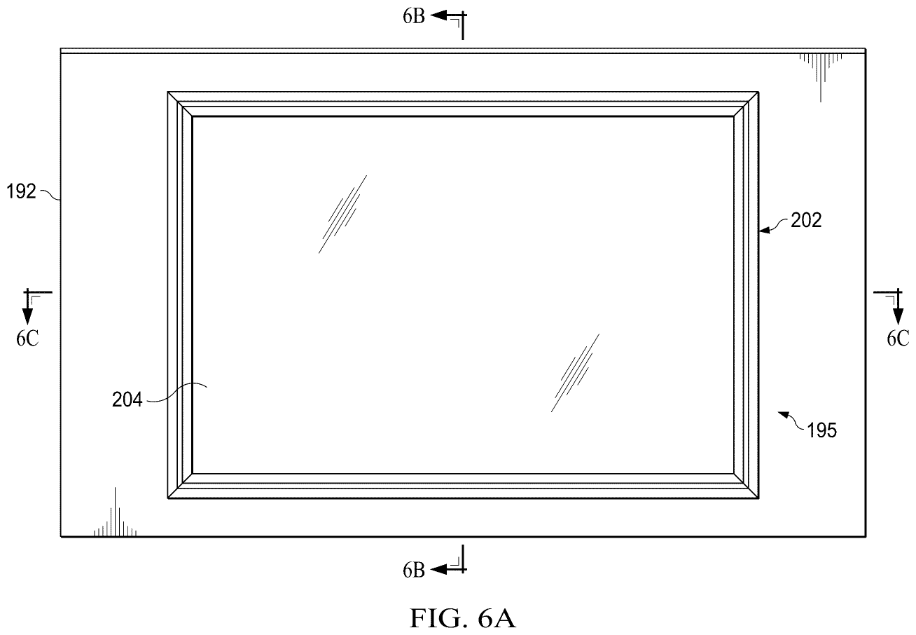

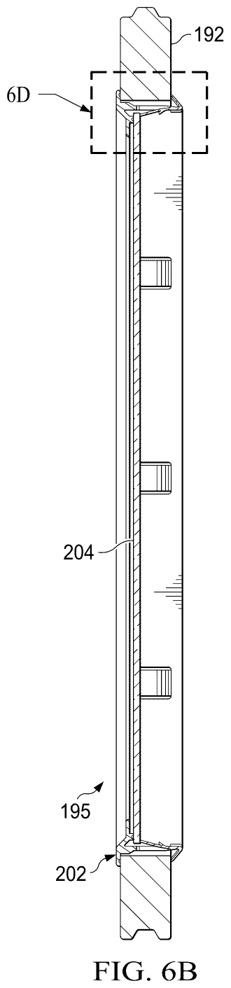

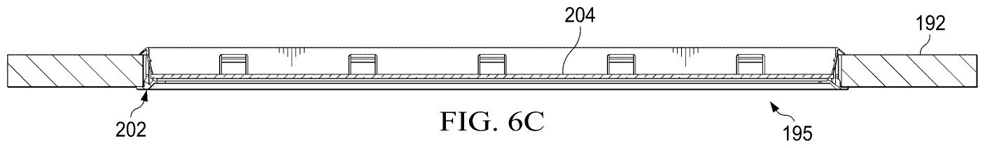

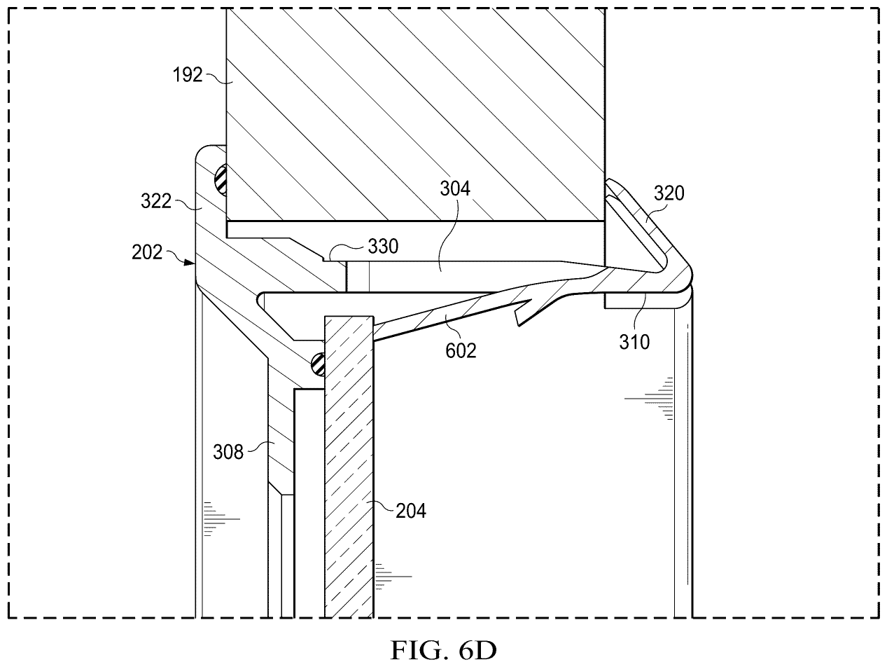

FIG. 6A is a front view of an example frame assembly 195 and panel 192, according to some aspects of the present disclosure. The frame assembly 195 includes the one-piece frame 202 and the pane 204.

FIG. 6B is a cross-section view of the example frame assembly 195 and panel 192 in FIG. 6A, according to some aspects of the present disclosure. That is, FIG. 6B may be a cross-section of FIG. 6A about Section Line 6B.

FIG. 6C is a cross-section view of the example frame assembly 195 and panel 192 in FIG. 6A, according to some aspects of the present disclosure. That is, FIG. 6C may be a cross-section of FIG. 6A about Section Line 6C.

FIG. 6D is a detail view of Detail View Area 6D in the cross-section view of the frame assembly 195 and panel 192 in FIG. 6B, according to some aspects of the present disclosure. In some implementations, the one-piece frame 202 may include one or more configurable members 602 which may be compatible with more than one size of pane 204 thickness. In some implementations, in addition to increased compatibility, the one or more configurable members 602 may have some or all of the capabilities and features of a member 302.

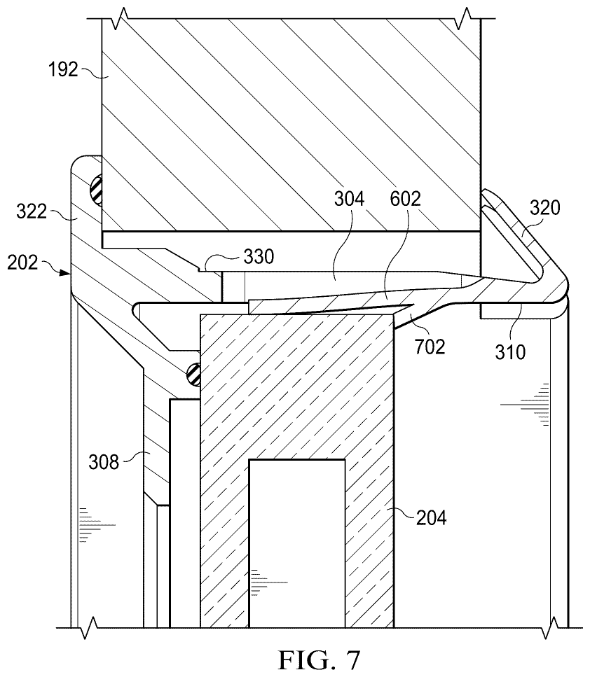

FIG. 7 is another example of a detail view of Detail View Area 6D in the cross-section view of the example frame assembly 195 and panel 192 in FIG. 6B, according to some aspects of the present disclosure. In some implementations, the one or more configurable members 602 may include one or more secondary members 702. The one or more secondary members 702 may extend from at least one side, such as the inner side, of the one or more configurable members 602. In some implementations, the one or more secondary members 702 may extend at an angle between 0 degrees and 90 degrees relative to the inner side of the one or more configurable members 602. The one or more secondary members 702 may be configured to accommodate another glass size. The one or more secondary members 702 may have a shorter extension length than the one or more configurable members 602, allowing the one or more secondary members 702 to accommodate a larger glass thickness. In some implementations, a remaining portion of the one or more configurable members 602 may act as a support for the pane 204 by, for example, providing elastic resistance as the one or more configurable members 602 are displaced by the pane 204 and/or caused to move into the one or more holes 304.

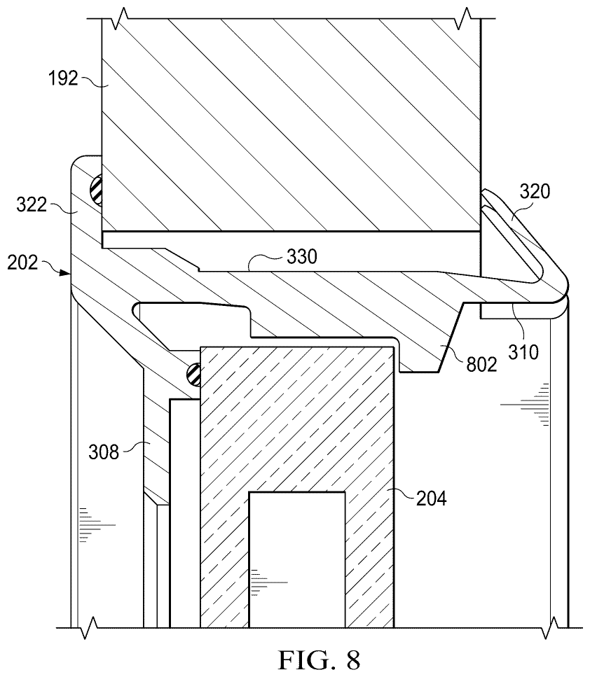

FIG. 8 is another example of a detail view of Detail View Area 6D in the cross-section view of the example frame assembly 195 and panel 192 in FIG. 6B, according to some aspects of the present disclosure. In some implementations, the one-piece frame 202 may include one or more continuous members 802 which may function without a hole 304 and may be compatible with more than one size of pane 204 thickness. Thus, the one or more continuous members 802 may have an extension extending from the continuous member 802 which may prevent a pane of a first thickness from moving in at least one direction and/or out of the one-piece frame 202 and the one or more continuous member 802 may have another extension extending from the continuous member 802 which may prevent a pane of a second thickness from moving in at least one direction and/or out of the one-piece frame 202. In some implementations, in addition to increased function and compatibility, the one or more continuous members 802 may have some or all of the capabilities and features of a member 302.

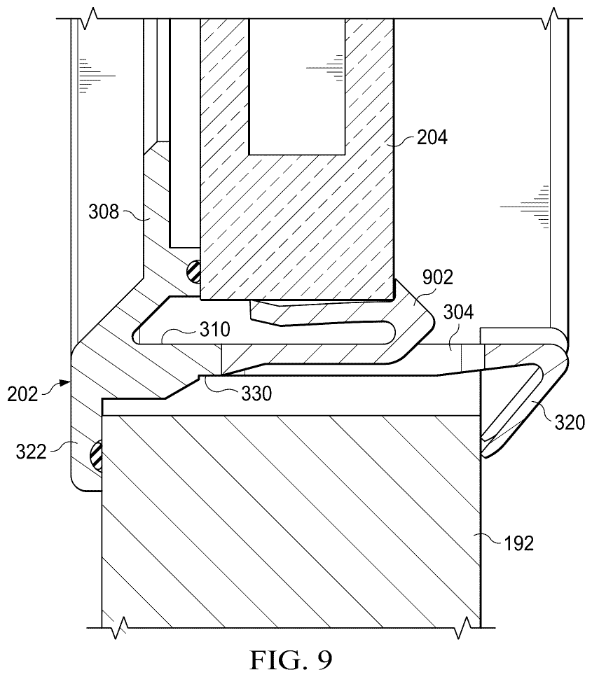

FIG. 9 is another example of a detail view of Detail View Area 6D in the cross-section view of the example frame assembly 195 and panel 192 in FIG. 6B if Detail View Area 6D were positioned at the other end of the frame assembly 195 in FIG. 6B, according to some aspects of the present disclosure. In some implementations, the one-piece frame 202 may include one or more flexing members 902 which may provide additional bending of the one or more flexing members 902 and may be compatible with more than one size of pane 204 thickness. Thus, in some implementations, the additional bending of the one or more flexing members 902 may provide additional support to the pane 204. In some implementations, the one or more flexing members 902 may include a U-shaped bend which may compress when the pane 204 engages one or more flexing members 902. Thus, a side of the pane 204 may engage with a side of the U-shaped bend of the one or more flexing members 902 causing at least a portion of the side of the U-shaped bend of the one or more flexing members 902 to move closer to the other side of the U-shaped bend of the one or more flexing members 902 which may create a biasing force against the pane 204. In some implementations, the one or more flexing members 902 may further comprise an extension positioned to prevent movement of the pane 204 in at least one direction and/or out of the one-piece frame 202. In some implementations, in addition to increased function and compatibility, the one or more flexing members 902 may have some or all of the capabilities and features of a member 302.

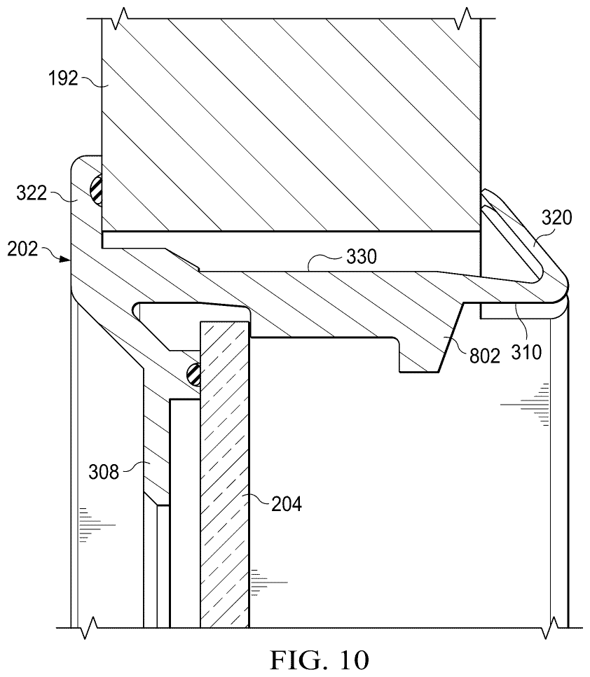

FIG. 10 is another example of a detail view of Detail View Area 6D in the cross-section view of the example frame assembly 195 and panel 192 in FIG. 6B, according to some aspects of the present disclosure. The example shown in FIG. 10 illustrates one of the one or more continuous members 802 being compatible with another size of glass thickness. Thus, the one or more continuous members 802 may have an extension extending from the continuous member 802 which may prevent a pane of a first thickness from moving in at least one direction and/or out of the one-piece frame 202 and the one or more continuous member 802 may have another extension extending from the continuous member 802 which may prevent a pane of a second thickness from moving in at least one direction and/or out of the one-piece frame 202.

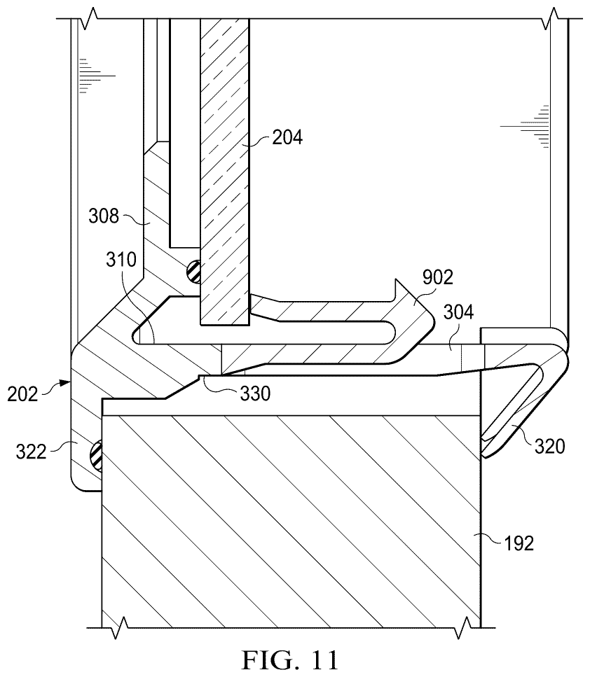

FIG. 11 is another example of a detail view of Detail View Area 6D in the cross-section view of the example frame assembly 195 and panel 192 in FIG. 6B if Detail View Area 6D were positioned at the other end of the frame assembly 195 in FIG. 6B, according to some aspects of the present disclosure. The example shown in FIG. 11 illustrates one of the one or more flexing members 902 being compatible with another size of glass thickness. Thus, in some implementations, the one or more flexing members 902 may further comprise an extension positioned at an end of the U-shaped bend of the one or more flexing members 902 to prevent movement of the pane 204 in at least one direction and/or out of the one-piece frame 202.

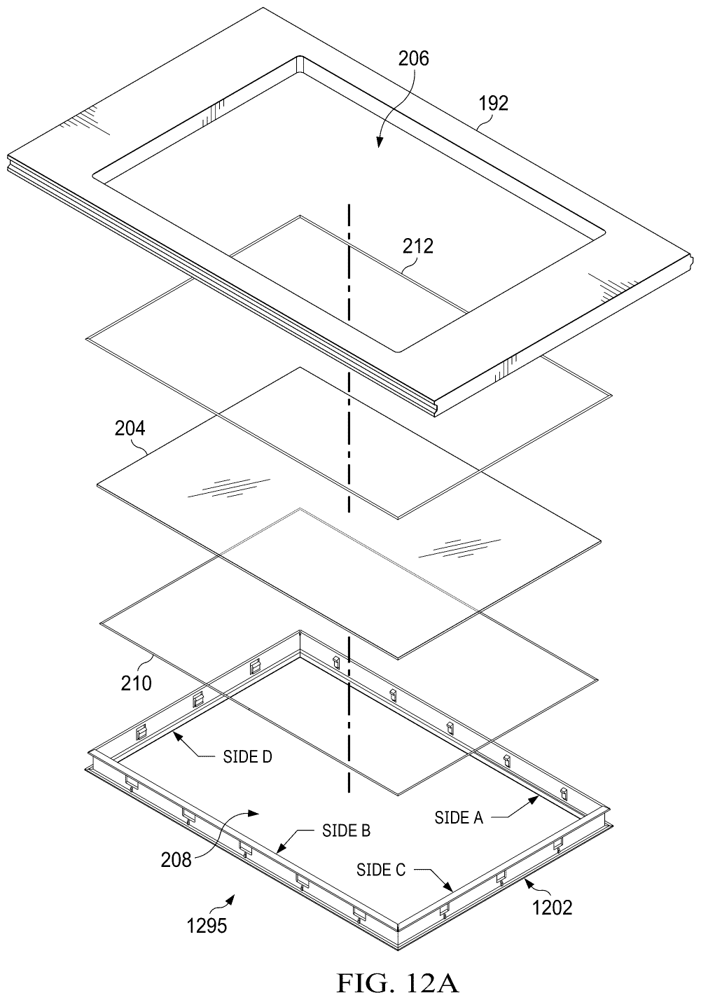

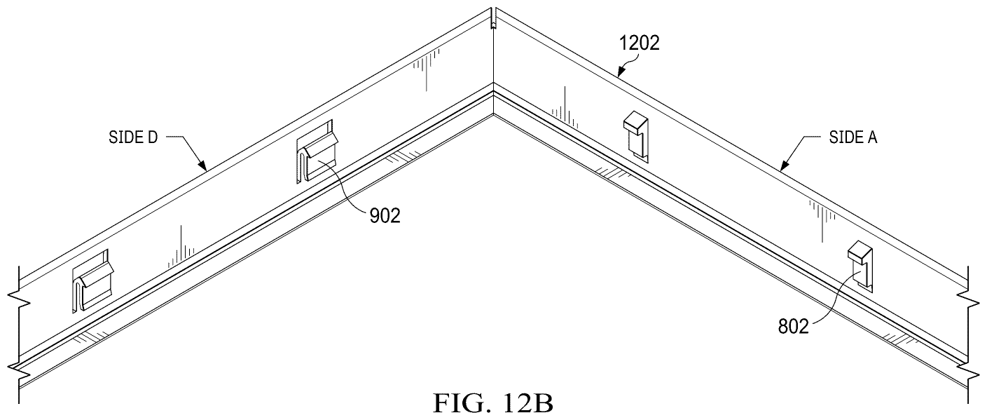

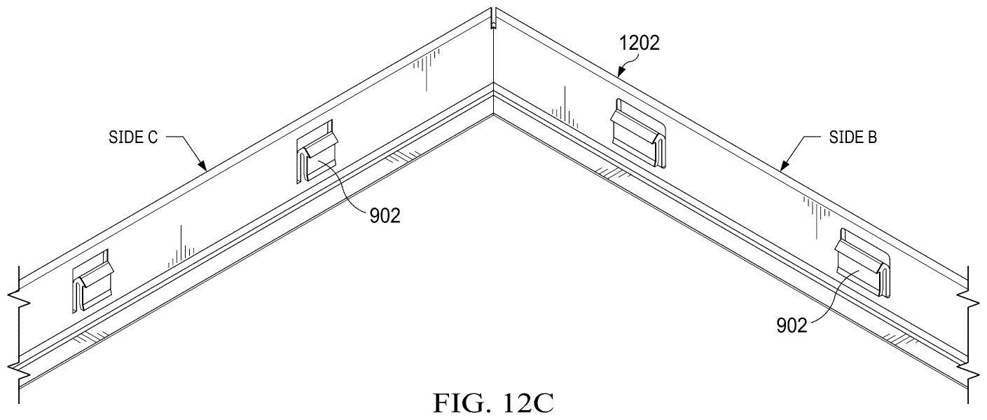

FIG. 12A is an exploded perspective view of an example frame assembly 1295 and panel 192, according to some aspects of the present disclosure. The frame assembly 1295 includes the one-piece frame 1202 and the pane 204. The one-piece frame 1202 may have Sides A, B, C, and/or D.

FIG. 12B is a perspective view Sides A and D of an example frame assembly 1295 as Sides A and D are labeled in FIG. 12A, according to some aspects of the present disclosure. FIGS. 12B-12C may help illustrate a process for positioning pane 204 in the one-piece frame 1202. In some implementations, Side A may include one or more continuous members 802. In some implementations, Side D may include one or more flexing members 902. In some implementations, a pane 204, such as a glass panel and/or glass, may be positioned under an extension on the one or more continuous members 802 (which may also be referred to as “stationary brackets”) along Side A.

FIG. 12C is a perspective view Sides B and C of an example frame assembly 1295 as Sides B and C are labeled in FIG. 12A, according to some aspects of the present disclosure. In some implementations, Sides B, C, and/or D may include one or more flexing members 902. In some implementations, after securing a side of the pane 204 to Side A, for example, as discussed with respect to FIG. 12B, the pane 204 may be carefully pressed into the one or more flexing members 902 (which may also be referred to as “flex clips” or “clips”) along Sides B, C, and/or D until the one or more flexing members 902 engage, securing the pane 204 in the one-piece frame 1202. Thus, in some implementations, the pane 204 may engage with a side of the U-shaped bend of the one or more flexing members 902 causing at least a portion of the side of the U-shaped bend of the one or more flexing members 902 to move closer to the other side of the U-shaped bend of the one or more flexing members 902 which may create a biasing force against the pane 204. The pane 204 may continue to slide past the U-shaped bend of the one or more flexing members 902 until the pane 204 passes an extension of the one or more flexing members 902 causing the pane 204 to lock into place and causing the U-shaped bend of the one or more flexing members 902 to return partially, substantially, or fully to its original position.

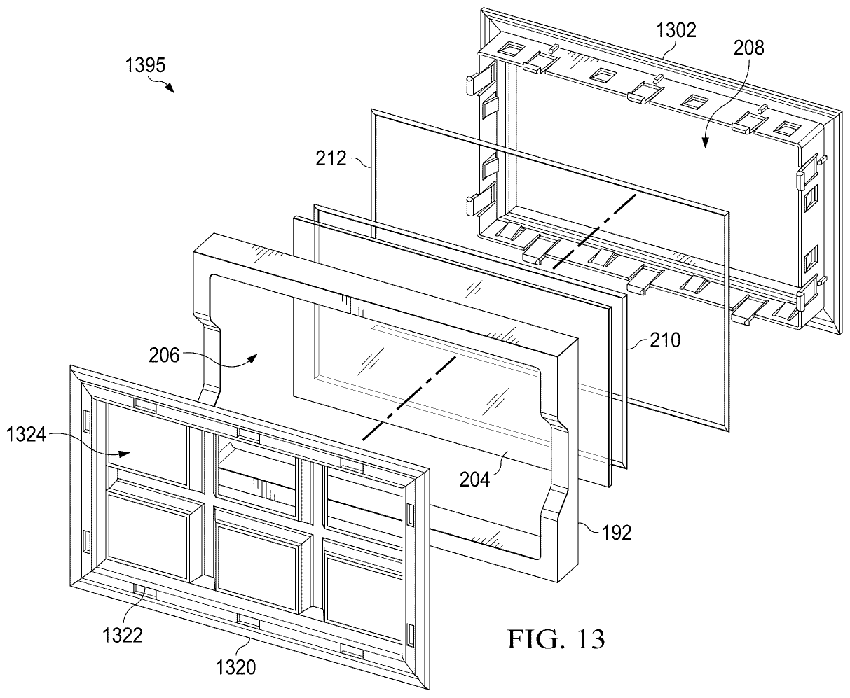

FIG. 13 is an exploded perspective view of an example frame assembly 1395 and panel 192, according to some aspects of the present disclosure. In some implementations, a frame assembly 1395 may include a one-piece frame 1302 and a trim 1320, which may also be referred to as a decorative trim, decorative trim insert, and/or a door trim. The frame assembly 1395 may couple with the panel 192. It should be understood that depending on the implementation, the frame assembly 1395 may include any features discussed with respect to the frame 202. The trim 1320 may be positioned on the interior side of the movable barrier 190 and may couple with a section panel 192 and/or the one-piece frame 1302, depending on the implementation. Depending on the implementation, the trim 1320 may be made of and/or molded from any material or materials including, for example, wood pulp, paper pulp, recycled plastics, resins, wax, plastic, rubber, foam, wood, steel, iron, aluminum, metal, alloy, and/or any other suitable material. In some implementations, the trim 1320 may include one or more reception holes 1322 and/or one or more sub-openings 1324. In implementations in which the trim 1320 includes one sub-opening 1324, it should be understood that the one sub-opening 1324 may be any size and/or shape, may have any position on the trim 1320, and/or may centered or off-centered. For example, the trim 1320 may conceal the barrier panel cutout 206 edge. In implementations in which the trim 1320 includes a plurality of sub-openings 1324, it should be understood that the one sub-opening may be any size and/or shape such that the portions of the trim 1320 separating the plurality of sub-openings 1324 may be vertical, horizontal, diagonal, curved, and/or any other orientation or shape.

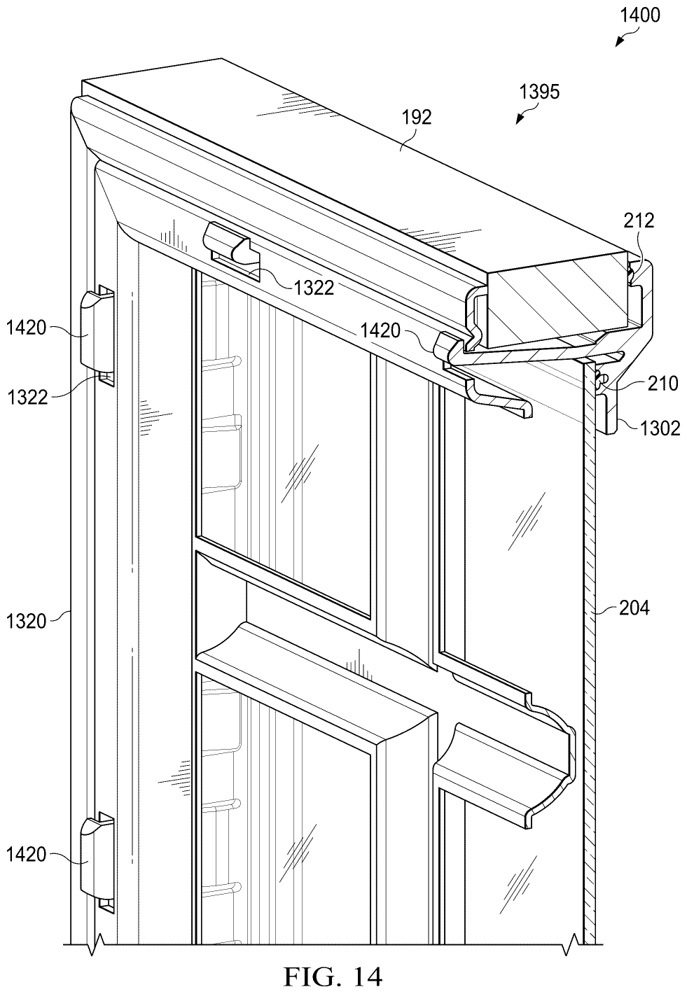

FIG. 14 is a perspective cross-section view of an example frame assembly 1395 and panel 192, according to some aspects of the present disclosure. In some implementations, the one or more reception holes 1322 of the trim 1320 may engage one or more flanges 1420 of the one-piece frame 1302. As the one-piece frame 1302 is inserted into the panel opening 206, the one or more reception holes 1322 may bend the one or more flanges 1420 as the one or more flanges 1420 insert into the one or more reception holes 1322. When the one or more flanges 1420 pass the one or more reception holes 1322 and the trim 1320, the one or more flanges 1420 may move fully, substantially, or towards the initial position of the one or more flanges 1420 and/or may snap the one-piece frame 1302 and/or the trim 1320 in position relative to the section panel 192. Thus, the trim 1320 may tighten and/or secure the one-piece frame 1302 to the section panel 192. In some implementations, the trim 1320 may be used as a decorative trim to hide any feature(s) of the panel 192 and/or the frame assembly 1395 including, for example, the one or more members 1502. Depending on the implementation, the trim 1320 may include various designs and appearance options including, for example, the one or more sub-openings 1324 such as the sub-openings 1324 shown in FIG. 14. The one or more sub-openings 1324 may open up to and/or be adjacent to a portion of the panel opening 206.

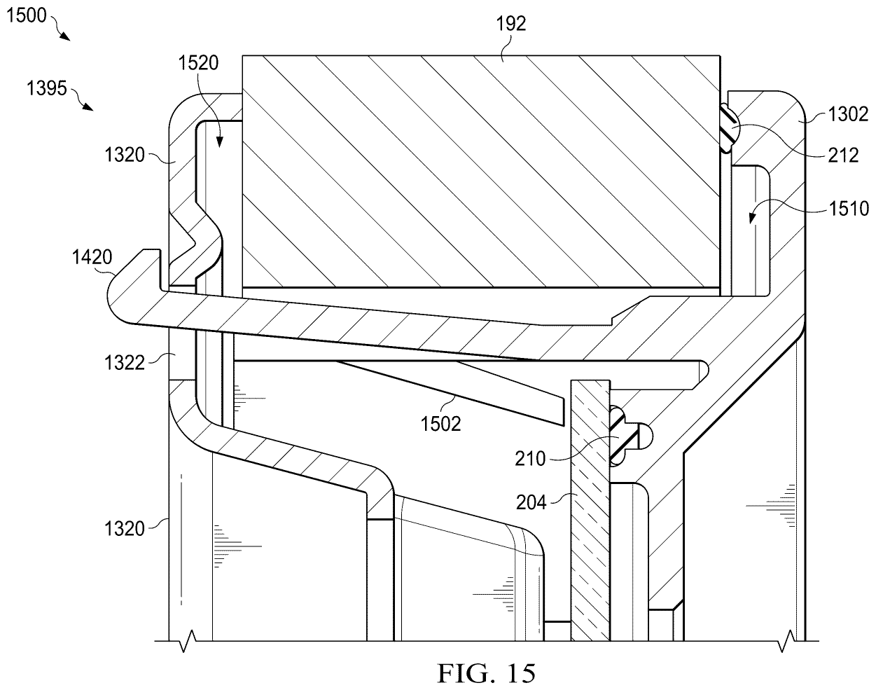

FIG. 15 is a side cross-section view of an example frame assembly 1395 and panel 192, according to some aspects of the present disclosure. In some implementations, when the one-piece frame 1302 and/or the trim 1320 couples to the section panel 192, one or more cavities, such as a first cavity 1510 and a second cavity 1520, may form. The first cavity 1510 may form between the one-piece frame 1302 and the section panel 192. The second cavity 1520 may form between the trim 1320 and the section panel 192. The one or more cavities 1510, 1520 may provide space for tolerance flexing of the elements in the frame assembly 1395 such as the section panel 192, the one-piece frame 1302, and/or the trim 1320. Thus, portions of the one-piece frame 1302 and/or the trim 1320 may be sized and shaped to flex when the one or more flanges 1420 are engaged and, in some implementations, flexing may account for variations within tolerances of parts of the frame assembly 1395 and panel 192. In some implementations, when the frame assembly 1396 does not include a trim 1320, the flanges 1420 of the one-piece frame 1302 may couple directly to the panel 192.

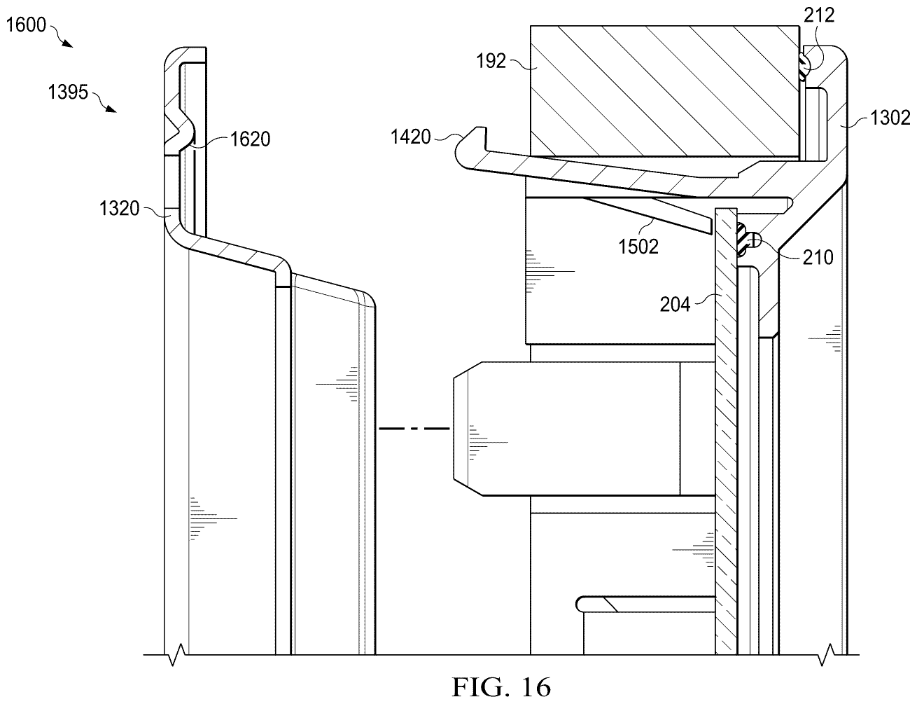

FIGS. 16-19 may illustrate examples of the trim 1320 engaging the one-piece frame 1302. FIG. 16 is a side cross-section view of an example frame assembly 1395 and panel 192, according to some aspects of the present disclosure. In some implementations, such as the example shown in FIG. 16, the trim 1320 may be positioned adjacent to and/or aligned with the one-piece frame 1302.

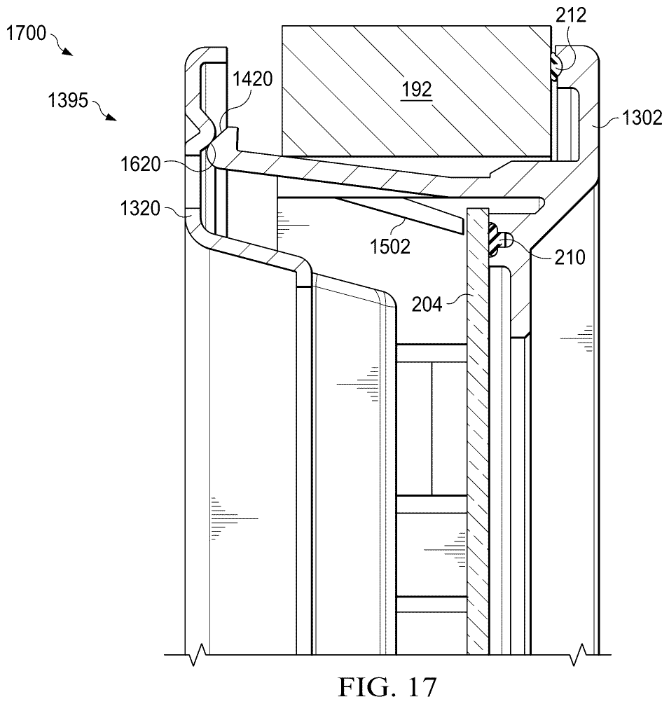

FIG. 17 is a side cross-section view of an example frame assembly 1395 and panel 192, according to some aspects of the present disclosure. In some implementations, such as the example shown in FIG. 17, one or more oblique portions 1620 (which may also be referred to as ramps) of the trim 1320 may engage the one or more flanges 1420 of the one-piece frame 1302. In some implementations, the one or more oblique portions 1620 of the trim 1320 may be at least partially downwardly facing.

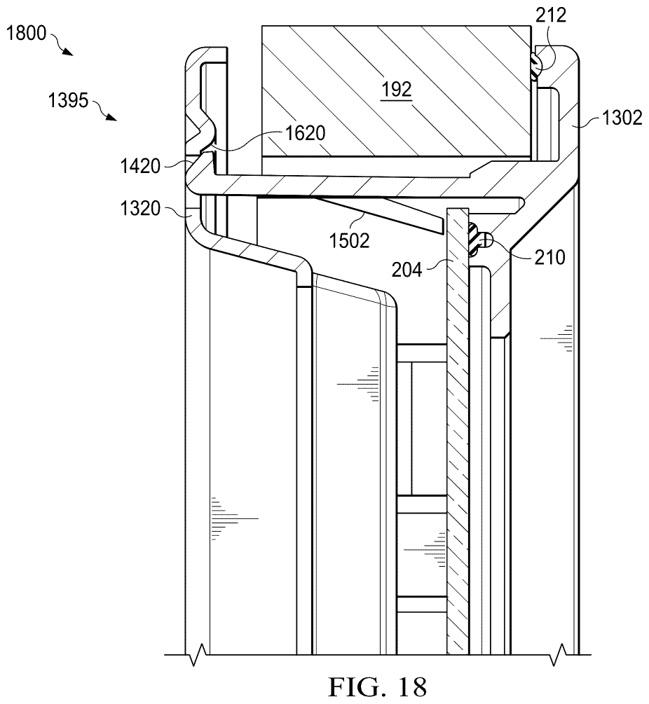

FIG. 18 is a side cross-section view of an example frame assembly 1395 and panel 192, according to some aspects of the present disclosure. In some implementations, such as the example shown in FIG. 18, the trim 1320 may flex and/or bend the one or more flanges 1420 of the one-piece frame 1302. In some implementations, a portion of the one or more flanges 1420 may slide against the one or more oblique portions 1620.

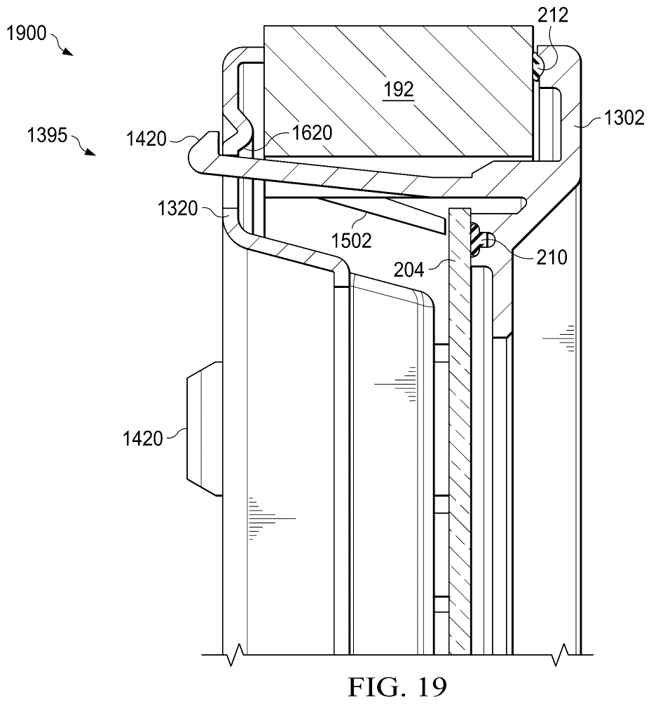

FIG. 19 is a side cross-section view of an example frame assembly 1395 and panel 192, according to some aspects of the present disclosure. In some implementations, such as the example shown in FIG. 19, the trim 1320 may move past the one or more flanges 1420 of the one-piece frame 1302 allowing the one or more flanges 1420 to move fully, substantially, or partially back towards the one or more flanges' 1420 initial position (e.g., the example position shown in FIG. 16) and/or allowing the one or more flanges 1420 to snap into place locking the one-piece frame 1302 and the trim 1320 in position relative to the section panel 192.

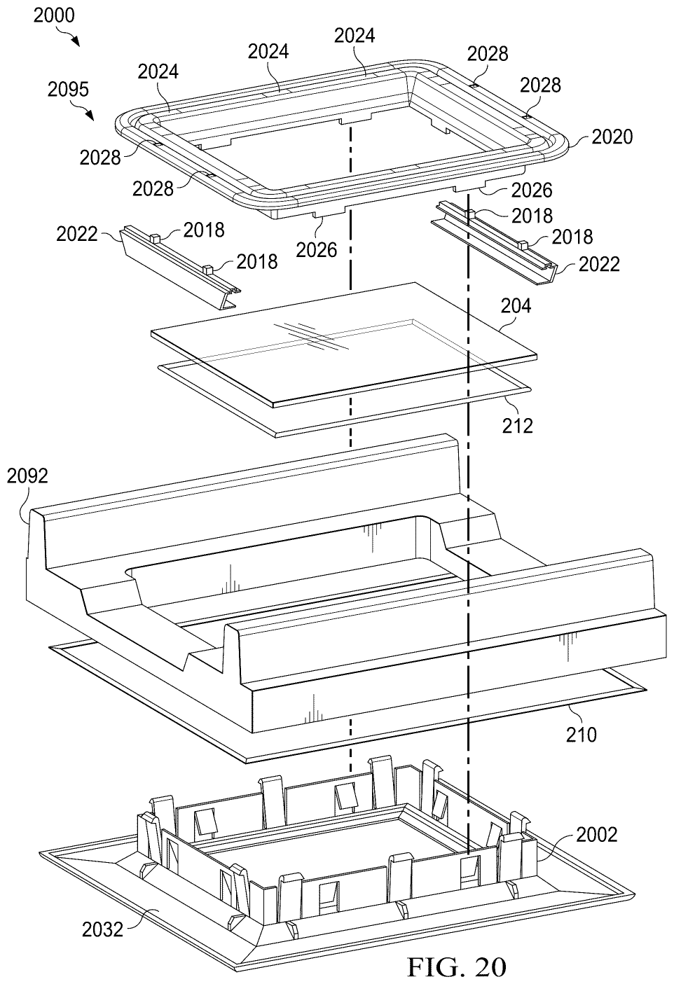

FIG. 20 is an exploded perspective view 2000 of an example frame assembly 2095 and panel 2092, according to some aspects of the present disclosure. In some implementations, including, for example, as shown in FIG. 20, a frame assembly 2095 may include a one-piece frame 2002 and a trim 2020, which may also be referred to as a decorative trim, decorative trim insert, and/or a door trim. The frame assembly 2095 may couple with the panel 192 or the panel 2092. It should be understood that depending on the implementation, the frame assembly 2096 may include any features discussed with respect to the frame assemblies 195, 1395 and/or any other implementation discussed herein. The trim 2020 may include one or more reception holes 2024 and one or more extensions 2026 which are discussed further herein. In some implementations, the one-piece frame 2002 may include an elongate outer ledge 2032.

In some implementations, the frame assembly 2095 may further include one or more skirts 2022 which may be coupled to the trim 2020, for example, to cover a gap between the trim 2020 and the panel 2092 in implementations in which the panel 2092 has multiple thicknesses and/or contours including, for example, Wayne-Dalton 9100 garage doors. Thus, the one or more skirts 2022 may couple to the trim 2020 such that all or most of the frame assembly 2095 will be flush with the panel 2092. In some implementations, the trim 2020 may further include one or more retainer holes 2028 which may each couple with a peg 2018 of the one or more skirts 2022 to secure the one or more skirts between the panel 2092 and the trim 2020. In some implementations, the frame assembly 2095 may have two skirts 2022.

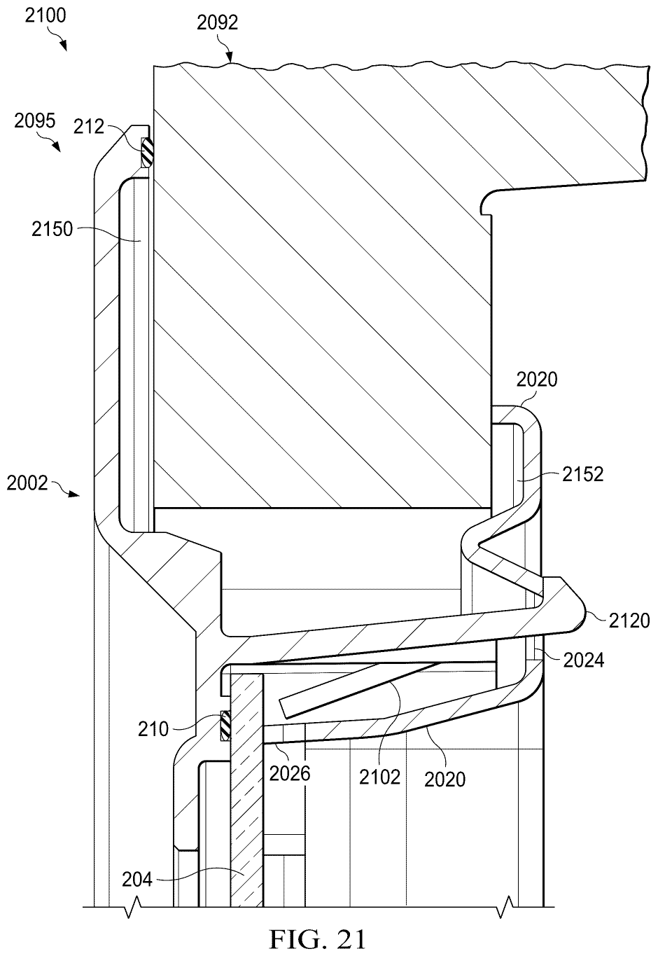

FIG. 21 is a side cross-section view 2100 of an example frame assembly 2095 and panel 2092, according to some aspects of the present disclosure. In some implementations, the trim 2020 may include one or more extensions 2026 which may couple with the pane 204 when the frame assembly 2095 couples with the panel 2092. The extensions 2026 may provide numerous benefits including, for example, aiding in the installation of the pane 204 and providing additional support to the pane from the trim 2020 against forces such as wind load forces or object impacts. The one or more extensions 2026 may aid in installation of the pane 204 by aligning with the member 2102 of the one-piece frame 2002 and applying an a least partially opposing force on the back surface of the pane 204 against the force of the member 2102 on the side on the pane 204, potentially reducing the chance of damage to the pane 204. Thus, in some implementations, the one or more extensions 2026 may simultaneously push the pane 204 into the one or more members 2102 and secure the pane 204 in one single movement.

In some implementations, the elongate outer ledge 2032 may extend relatively further up the panel 2092. In some implementations, at least a portion of the portion of the one-piece frame 2002 overlapping the pane 204 in the frame opening may not be in contact with the pane 204, potentially reducing wear on the pane 204.

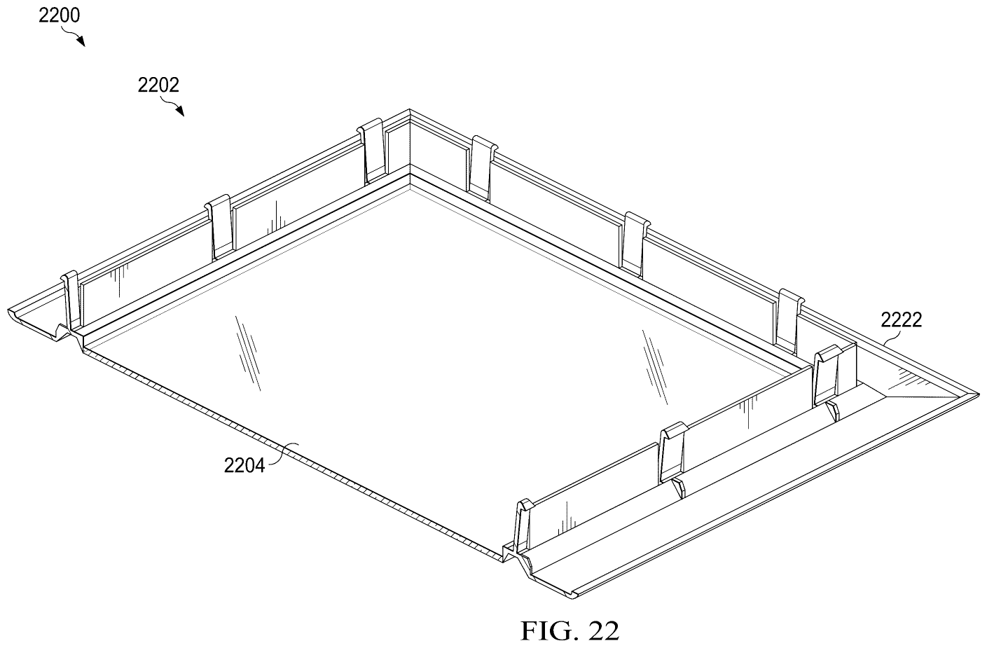

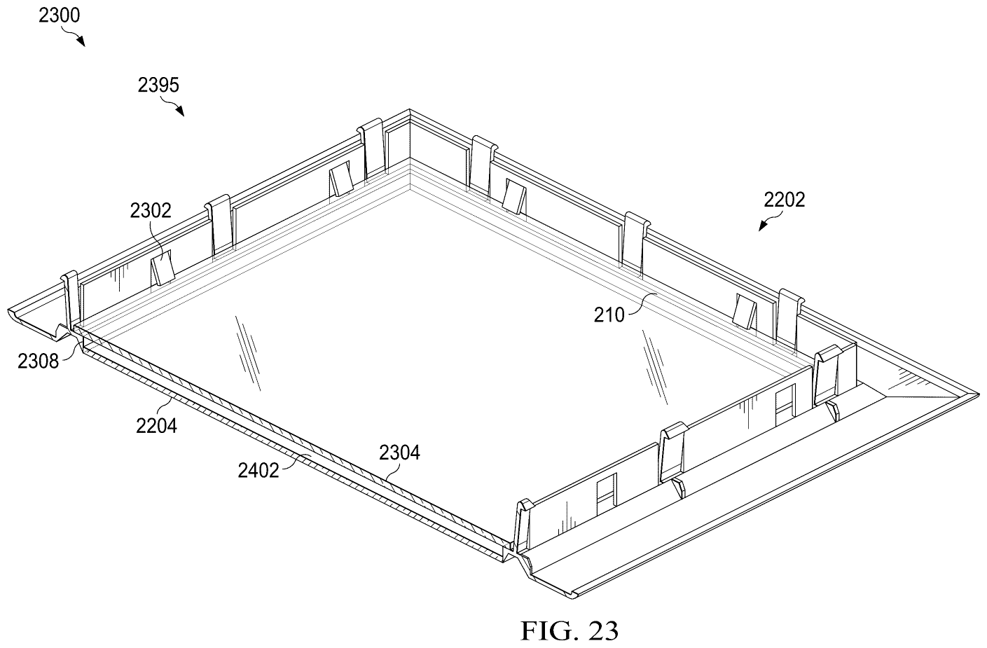

FIG. 22 is a cross-sectional perspective view 2200 of an example frame 2202, according to some aspects of the present disclosure. In some implementations, the frame assembly 195, 1395, 2095 or any other frame assembly discussed herein may include a one-piece frame 2202. The one-piece frame 2202 may include an integral pane 2204. In some implementations the one-piece frame 2202 and the integral pane 2204 may be molded as one-piece. The one-piece frame 2202 with integral pane 2204 may provide numerous benefits including, for example, reducing manufacturing costs, reducing inventory costs, and/or reducing installation time and costs. Thus, the one-piece frame 2202 may be inserted into the panel 192, 2092 with the integral pane 2204 already incorporated. In some implementations, the one-piece frame 2202 may include one or more members (not shown), which may have any of the features discussed in relation to any of the members discussed herein including, for example, members 302, 402, 602, 802, 902, 1502, 2102, 2302. The one-piece frame 2202 may have one or more members to add additional panes to the one-piece frame other than the integral pane 2204 such as a second pane 2304 as discussed in relation to FIG. 23 further herein. It should be understood that depending on the implementation, the one-piece frame 2202 and/or the integral pane 2204 may have any thicknesses depending, for example, on overall size and/or application. For example, in some implementations, the integral pane 2204 may be about ⅛ inches thick and/or about 1/16 inches to ¼ inches thick. In some implementations, when the frame assembly is being used for a heavy wind load application, an impact rating for high wind load certification ratings may be applied. For example, while depending on the implementation the integral pane 2204 may have any thickness or thicknesses, in some implementations, a wind load impact rated integral pane 2204 may be about ¼ inches thick and/or about ⅛ inches to ½ inches thick. It should be understood that the integral pane 2204 may be made of the same or different material or materials than the one-piece frame 2202 and/or the integral pane may be made of any material or materials including, for example, clear translucent polycarbonate, glass, plastic, plexiglass, acrylic, and/or any other type of suitable material. Notably the one-piece frame 2202 may include any of the features discussed in relation to any of the one-piece frames discussed herein including, for example, one-piece frames 202, 410, 1202, 1302, 2002. In some implementations, the one-piece frame 2202 may further include an elongate outer ledge 2222.

FIG. 23 is a cross-sectional perspective view 2300 of an example frame assembly 2395, according to some aspects of the present disclosure. In some implementations, a frame assembly 2395 may include at least some or all of a one-piece frame 2202, a second pane 2304, an insulation gap 2402 and/or a sealant bead 210. In some implementations, the second pane 2304 may be coupled to and/or secured to the integral pane 2204 with the sealant bead 210. In some implementations, the second pane 2304 may be positioned adjacent to the integral pane 2204 by being coupled or secured by the sealant bead 210 to a portion of the one-piece frame 2202 such as ledge 2308 extending into the frame opening substantially or fully parallel to the integral pane 2204. In some implementations, the integral pane 2204 may be integral with or may abut against the ledge 2308. In some implementations, the integral pane 2204 may be positioned a distance apart from the ledge 2308.

In some implementations, the one-piece frame 2202 may include members 2302 which may have any of the features discussed in relation to any of the members discussed herein including, for example, members 302, 402, 602, 802, 902, 1502, 2102, 2302. In some implementations, the members 2302 may secure the second pane 2304 within the frame opening of the one-piece frame 2202 instead of or in addition to the sealant bead 210. In some implementations, the frame assembly may further include a trim 1320, 2020. In some implementations, the trim 2020 may secure the second pane 2304 within the frame opening of the one-piece frame 2202. In some implementations, the second pane 2304 may couple to and/or abut against the integral pane 2204. In some implementations, the second pane 2304 may be spaced a distance apart from the integral pane 2204 and/or may have a front surface and a back surface substantially or fully parallel to the front surface and back surface of the integral pane 2204. In some implementations, the insulation gap 2402 may be positioned between the integral pane 2204 and the second pane 2304 such that the integral pane 2204 and the second pane 2304 are positioned a distance apart, the fluid, such as air, positioned within the insulation gap 2402 may provide additional insulation to the frame assembly 2395. In some implementations, the second pane 2304 and/or sealant bead 210 may provide additional insulation to the frame assembly 2395. In some implementations, the frame assembly 2395 including the one-piece frame 2202 and the second pane 2304 may be referred to as an insulated glass unit (IGU) and/or an insulated glazing unit (UGA). In some implementations including the second pane 2304, fasteners such as screws may be used to secure the second pane 2304 within the frame opening of the one-piece frame 2202 instead of or in addition to any of the other coupling mechanisms discussed herein.

It should be understood that although implementations in this disclosure may be referred to with words such as “upper,” lower,” “downwardly,” and “upwardly,” all implementations disclosed herein may be configured in any orientation and/or direction. It should also be understood that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A movable barrier system comprising:
a panel comprising a panel opening;
a one-piece frame configured to be positioned within the panel opening in a manner that an outer surface of the one-piece frame couples with at least a portion of the panel, the one-piece frame defining a frame opening and further comprising:
an inner surface substantially opposite the outer surface;
a member extending at an angle not more than about 90 degrees relative to the inner surface; and
a ledge extending from the inner surface; and
a pane configured to move into the frame opening in a manner that the pane engages the member and elastically deflects the member until the pane moves past the member.

2. The movable barrier system of claim 1, wherein the one-piece frame further comprises a second member extending at a second angle not more than 90 degrees relative to the inner surface.

3. The movable barrier system of claim 2, further comprising a second pane configured to move into the frame opening of the one-piece frame in a manner that the second pane engages the second member to extend substantially parallel to the inner surface until the second pane moves adjacent to the pane.

4. The movable barrier system of claim 1, wherein the member further comprises a secondary member, the secondary member extending from the member and configured to extend substantially parallel to the inner surface until the pane moves adjacent to the ledge.

5. The movable barrier system of claim 4, further comprising a second pane being thicker than the pane and being configured to move into the frame opening of the one-piece frame in a manner that the second pane engages the second member to extend substantially parallel to the inner surface until the second pane moves adjacent to the ledge.

6. The movable barrier system of claim 1, wherein the member further comprises a U-shaped bend, the U-shaped bend configured to compress when the pane engages the member.

7. The movable barrier system of claim 1, further comprising a sealant bead being positioned on the ledge and being configured to be positioned between the one-piece frame and the pane.

8. A movable barrier system having a one-piece frame for a panel of a movable barrier, the movable barrier system comprising:
the panel comprising an opening; and
the one-piece frame being configured to be positioned within the opening in a manner that at least one outer surface of the one-piece frame couples with at least a portion of the panel, the one-piece frame further comprising:
a flange extending at an angle not more than about 90 degrees relative to the outer surface of the one-piece frame in a manner that when the one-piece frame is positioned within the opening, the flange may engage a portion of the panel bending inwardly until the flange reaches an end of the opening; and
an outer ledge extending from the outer surface and configured to couple with the panel when the flange reaches an end of the opening.

9. The movable barrier system of claim 8, wherein when the flange reaches an end of the opening, the flange may be unengaged by the panel and firmly press against the panel securing the panel in place.

10. The movable barrier system of claim 8, wherein when the flange engages a portion of the panel, the flange may extend at a second angle less than the angle relative to the outer surface of the one-piece frame.

11. The movable barrier system of claim 10, wherein after the flange extends at the second angle and the flange reaches an end of the opening, the flange may snap back into place and extend at the angle.

12. The movable barrier system of claim 8, wherein the flange is further configured to extend at an angle not more than about 45 degrees relative to the outer surface of the one-piece frame.

13. The movable barrier system of claim 8, further comprising a tool configured to bend the flange outwardly out of the opening before the flange reaches an end of the opening.

14. The movable barrier system of claim 8, further comprising a second sealant bead being positioned on the outer ledge and being configured to be positioned between the one-piece frame and the panel.

15. A frame for placement in a panel opening of a panel of a movable barrier system, the frame defining a frame opening for a pane, comprising:
a leading side comprising a flexible flange formed thereon, the flexible flange being configured to flex into a first position while the leading side is introduced into the panel, the flexible flange also being configured to displace to a second position abutting against a first side of the panel adjacent the panel opening;
a trailing side comprising an outer ledge, the outer ledge being arranged to abut against a second side of the panel opposite the first side of the panel, the outer ledge being configured to prevent the frame from passing through the panel opening; and
a member extending inwardly into the frame opening at an oblique angle, the member being configured to flex into a first position while the pane is introduced into the frame, the member also being configured to displace to a second position abutting against a trailing side of the pane in a manner securing the pane in the frame.

16. The frame of claim 15, further comprising a second member extending inwardly into the frame opening at the oblique angle, the second member being configured to flex into a first position while a second pane is introduced into the frame, the second member also being configured to displace to a second position abutting against a trailing side of the second pane in a manner securing the second pane in the frame.

17. The frame of claim 15, wherein the member further comprises a secondary member, the secondary member extending from the member and extending inwardly into the frame opening at a second oblique angle, the secondary member being configured to flex into a first position while a second pane is introduced into the frame, the secondary member also being configured to displace to a second position abutting against a trailing side of the second pane in a manner securing the second pane in the frame.

18. The frame of claim 17, wherein the second pane is further configured to be thicker than the pane.

19. The frame of claim 15, wherein the member further comprises a U-shaped bend, the U-shaped bend configured to compress while the pane is introduced into the frame.

20. The frame of claim 15, further comprising a sealant bead being configured to be positioned between the frame and the pane.

21. The movable barrier system of claim 8, further comprising a trim configured to be at least partially positioned between the flange and a side of the panel.

22. The movable barrier system of claim 8, further comprising:
a pane disposed within a frame opening of the frame; and
a trim configured to be at least partially positioned between the flange and a side of the panel, at least a portion of the trim abutting a back surface of the pane.

23. The movable barrier system of claim 8, further comprising:
a pane integrated into the one-piece frame;
a second pane disposed within a frame opening of the frame; and
a trim configured to be at least partially positioned between the flange and a side of the panel, at least a portion of the trim abutting the back surface of the second pane.

24. A frame for placement in a panel opening of a panel of a movable barrier system, the frame comprising:
a pane integrated into the frame;
a leading side comprising a flexible flange formed thereon, the flexible flange being configured to flex from an initial position into a first position while the leading side is introduced into the panel from a first side, the flexible flange also being configured to displace to a second position, the second position being between the first position and the initial position;
a trailing side comprising an outer ledge, the outer ledge being arranged to abut against a second side of the panel opposite the first side of the panel, the outer ledge being configured to prevent the frame from passing through the panel opening; and
a frame opening defined by the frame, the pane at least partially obstructing the frame opening between the leading side and the trailing side.

25. The frame of claim 24 further comprising:
a member extending inwardly into the frame opening at an oblique angle, the member being configured to flex into a first position while a second pane is introduced into the frame, the member also being configured to displace to a second position abutting against a trailing side of the second pane in a manner securing the second pane in the frame.
